(19) United States
(12) Patent Application Publication
(10) Pub. No.: US 2026/0258260 A1
(43) Pub. Date: Sep. 3, 2026

(54) ANTI-FOG FUNCTIONAL COATING COMPOSITION, METHOD OF PREPARING THE SAME, AND COATING METHOD USING THE SAME

(71) Applicant: RAY MATERIALS CO., LTD., Gimje-si (KR)

(72) Inventor: Sang Soo YOU, Buan-gun (KR)

(21) Appl. No.: 19/655,615

(22) Filed: Apr. 22, 2026

Related U.S. Application Data
(63) Continuation of application No. PCT/KR2024/013881, filed on Sep. 12, 2024.

(30) Foreign Application Priority Data
Oct. 26, 2023 (KR) 10-2023-0144875

(51) Int. Cl. C09D 5/16; C08G 77/42; C08K 3/36; C08K 5/098; C09D 7/61; C09D 7/63; C09D 183/10

(52) U.S. Cl. CPC C09D 5/1637; C08G 77/42; C09D 5/1618; C09D 5/1625; C09D 7/61; C09D 7/63; C09D 183/10; C08K 3/36; C08K 5/098

(57) ABSTRACT

The effect of maintaining anti-fog functionality semi-permanently is provided herein. Further, since the provided enables both hydrophilicity and hydrophobicity, the surface of a substrate becomes smoother after coating, thereby enhancing hardness and improving durability. The coating composition and the coating method herein may be applied to industrial fields where anti-fog functionality is essential, and to various substrates, such as metal, glass, and polymer substrates.

### TECHNICAL FIELD

The present disclosure relates to an anti-fog functional coating composition and a coating method using the same.

### BACKGROUND

“Anti-fog” refers to the suppression of condensation (fogging) in the form of small droplets on the surface of an object. This technology is frequently applied to transparent glass or plastic surfaces used in optical applications, such as eyeglasses, goggles, and camera lenses.

Meanwhile, the global market for anti-fog additives is expected to grow from USD 335 million in 2019 to USD 483.75 million by 2027 (at a compound annual growth rate of 4.7%). As mask wearing has become part of daily life due to the recent COVID-19 pandemic, the demand for anti-fog technology is expected to increase significantly.

An anti-fog functional composition containing a short-chain fluorinated alkyl group (Korean Patent No. 10-1843053) is an example of a previously developed anti-fog composition. However, conventional anti-fog technologies suffer from significant deterioration of anti-fog functionality within a short period of time. Accordingly, there is an ongoing need for in-depth development and diverse research on anti-fog functional compositions that exhibit superior effectiveness and maintain anti-fog functionality over an extended period.

### DISCLOSURE OF THE INVENTION

### Problems to be Solved by the Invention

The present disclosure has been conceived to address the problem that the anti-fog effect of conventional anti-fog technologies does not persist for a long period of time. Further, the present disclosure aims to improve the durability and hardness of a coated material.

However, there may be other problems which can be clearly understood by a person with ordinary skill in the art from the following descriptions.

### Means for Solving the Problems

A first aspect of the present disclosure provides an anti-fog functional coating composition.

A second aspect of the present disclosure provides a method of preparing an anti-fog functional coating composition, the method including: stirring a hydrophilic material, a hydrophobic material, and a trench-structure or groove-structure forming agent.

A third aspect of the present disclosure provides a coating method using an anti-fog functional coating composition, the method including: forming a coating layer on a substrate using the composition according to the present disclosure.

A fourth aspect of the present disclosure provides a coating object coated with the composition according to the present disclosure.

However, there may be other aspects which can be clearly understood by a person with ordinary skill in the art from the following descriptions.

### Effects of the Invention

The present disclosure provides the effect of maintaining anti-fog functionality semi-permanently. Further, since the present disclosure enables both hydrophilicity and hydrophobicity, the surface of a substrate becomes smoother after coating, thereby enhancing hardness and improving durability. The coating composition and the coating method according to the present disclosure may be applied to industrial fields where anti-fog functionality is essential, and to various substrates, such as metal, glass, and polymer substrates.

However, there may be other effects which can be clearly understood by a person with ordinary skill in the art from the following descriptions.

### BRIEF DESCRIPTION OF THE DRAWINGS

FIG. 1 is a cross-sectional view illustrating a coating layer formed on a substrate using an anti-fog functional coating composition according to an embodiment of the present disclosure.

### BEST MODE FOR CARRYING OUT THE INVENTION

Hereinafter, embodiments will be described in detail with reference to the accompanying drawings so that the present disclosure may be readily implemented by a person with ordinary skill in the art. However, it is to be noted that the present disclosure is not limited to the embodiments but can be embodied in various other ways. In the drawings, parts irrelevant to the description are omitted for the simplicity of explanation, and like reference numerals denote like parts throughout the whole document.

Throughout the whole document, the term “on” that is used to designate a position of one element with respect to another element includes both a case that the one element is adjacent to the other element and a case that any other element exists between these two elements.

Further, throughout the whole document, the term “comprises or includes” and/or “comprising or including” used in the document means that one or more other components, steps, operation and/or existence or addition of elements are not excluded in addition to the described components, steps, operation and/or elements unless context dictates otherwise.

Throughout the whole document, the term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party. Throughout the whole document, the term “step of” does not mean “step for.”

Throughout the whole document, the term “combination(s) of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

Throughout the whole document, a phrase in the form “A and/or B” means “A or B, or A and B.”

Throughout the whole document, the term “anti-fog” refers to the suppression of fogging. In many technical fields, water vapor causes performance degradation of products. Representative examples include fogging of automobile windows on rainy days and fogging of lenses when wearing a mask. The term “anti-fog” refers to the suppression of fogging on such products.

Hereinafter, embodiments and examples of the present disclosure will be described in detail with reference to the accompanying drawings. However, the present disclosure may not be limited to the following embodiments, examples, and drawings.

Conventional anti-fog technologies have a drawback in that the anti-fog effect is maintained only temporarily and does not persist over a long period of use. This drawback is due to the low durability of conventional technologies. Conventional anti-fog coating technologies have drawbacks in that the coating may peel off due to scratches over time, or the performance of the coating itself may degrade, thereby limiting long-term use.

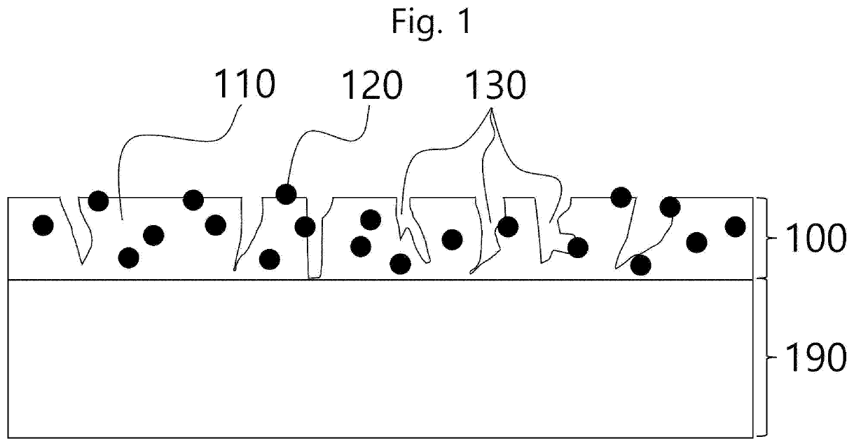

Accordingly, the present disclosure addresses the above-described problems by including a hydrophilic material and a hydrophobic material in an anti-fog functional coating solution and further allowing a trench-structure or groove-structure to be formed in a coating layer after coating (FIG. 1). Specifically, the degree of anti-fog functionality can be adjusted by including the hydrophilic material, which provides the anti-fog functionality, and the hydrophobic material, which increases the surface hardness of the coating layer, in an appropriate ratio. Therefore, according to the present disclosure, the anti-fog functionality can be adjusted to meet the requirements of the specific technical field in which the coating solution is used.

Further, in the coating layer formed after coating, the hydrophobic material is interposed between hydrophilic materials, and thus the surface hardness can be increased by the hydrophobic material. An increase in surface hardness signifies an improvement in the durability of the coating layer, thereby enabling semi-permanent anti-fog functionality.

Furthermore, a trench-structure or groove-structure may be formed in the coating layer after coating. Since the trench-structure or groove-structure increases the overall surface area of the coating layer, the area where the hydrophilic material contacts the air is increased compared to a coating layer without such structures, thereby further enhancing the anti-fog functionality. The trench-structure or groove-structure of the present disclosure may be a structure formed by a crosslink reaction using a forming agent therefor, such as a “trench-structure or groove-structure forming agent,” but is not necessarily limited thereto.

A first aspect of the present disclosure provides an anti-fog functional coating composition.

The composition according to the present disclosure includes a hydrophilic material and a hydrophobic material, and a trench-structure or groove-structure is formed in a coating layer after coating (FIG. 1).

The degree of anti-fog functionality and the surface hardness can be controlled by adjusting a mixing ratio of the hydrophilic material and the hydrophobic material. Accordingly, the coating solution can be used in various technical fields.

Since the hydrophobic material is interposed between the hydrophilic materials, it is possible to obtain not only the anti-fog effect via the hydrophilic material but also an increased surface hardness via the hydrophobic material.

The surface area of the coating layer is increased by the trench-structure or groove-structure formed in the coating layer after coating. That is, since the surface area of the hydrophilic material increases, the anti-fog functionality can be further enhanced.

According to an embodiment of the present disclosure, the hydrophilic material includes at least one selected from the group consisting of (3-glycidyloxypropyl)trimethoxysilane, silicon oxide (SiO₂), epoxy resin, polyethylene glycol (PEG), polyvinyl alcohol, polyvinyl acetate, polyvinyl pyrrolidone, and polyoxazoline. The hydrophobic material may include at least one selected from the group consisting of chromium oxide, aluminum triisopropylate, polycarbonate, polyethylene terephthalate glycol, and polypropylene.

Any coating material that exhibits anti-fog functionality or increases the surface hardness of a coating layer should be interpreted as being included within the hydrophilic material and the hydrophobic material according to the present disclosure.

According to an embodiment of the present disclosure, the trench-structure or groove-structure may be formed by at least one of itaconic acid and dicyandiamide. Any material capable of forming a trench-structure or groove-structure in a coating layer is intended to be included within the scope of the present disclosure. Hereinafter, such materials will be referred to as a “trench-structure or groove-structure forming agent.”

In an embodiment of the present disclosure, the anti-fog functional coating composition may include tetraethyl orthosilicate, (3-glycidyloxypropyl)trimethoxysilane, methyl acetoacetate, aluminum triisopropylate, acetic acid, acetylacetone, silicon oxide (SiO₂), epoxy resin, a surfactant, itaconic acid, and dicyandiamide.

Herein, tetraethyl orthosilicate serves for inorganic solidification; (3-glycidyloxypropyl)trimethoxysilane is a silicon-based silane intermediate serving for surface modification and crosslinking; methyl acetoacetate serves for stirring the mixture; aluminum triisopropylate is a metal oxide that provides a hydrophobic material to the finished coating composition; acetic acid serves as a reaction initiator between the mixtures; acetylacetone increases the crosslinkability of large, coarse particles and decreases the viscosity of the composition; silicon oxide serves for index control and surface hardness increase, exhibits anti-fog performance, and provides a hydrophilic material to the finished coating composition; epoxy resin, together with silicon oxide, provides a hydrophilic material to the coating composition; and the surfactant serves to smooth the interface when the coating composition is applied to a substrate. Also, itaconic acid and dicyandiamide serve to form a trench-structure or groove-structure on the surface of metal oxides, such as aluminum oxide and silicon oxide (Table 1).

TABLE 1

| Composition | Role |
|---|---|
| Tetraethyl orthosilicate | Inorganic solidification |
| (3-glycidyloxypropyl)trimethoxysilane | Silane intermediate, surface |
| | modification and crosslinking |
| Methyl acetoacetate | Stirring agent |
| Aluminum triisopropylate | Hydrophobic material |
| Acetic acid | Reaction initiator |
| Acetylacetone | Crosslinkability increase, |
| | viscosity decrease |
| Silicon oxide (SiO₂) | Index control, surface hardness |
| | increase, hydrophilic material |
| Epoxy resin | Hydrophilic material |
| Surfactant | Emulsifier |
| Itaconic acid | Cavity (trench-structure or |
| | groove-structure) formation |
| Dicyandiamide | Cavity (trench-structure or |
| | groove-structure) formation |

A second aspect of the present disclosure provides a method of preparing an anti-fog functional coating composition, the method including: stirring a hydrophilic material, a hydrophobic material, and a “trench-structure or groove-structure forming agent.” The hydrophilic material, hydrophobic material, and forming agent used herein are the same as those described in the first aspect. A stirring agent, an intermediate, a reaction initiator, or the like may be further used in the preparation process. For example, methyl acetoacetate or acetylacetone may be used as the stirring agent; (3-glycidyloxypropyl)trimethoxysilane may be used as the intermediate; and acetic acid may be used as the reaction initiator. Other materials may be added without departing from the scope of the present disclosure.

In an embodiment, an anti-fog functional coating solution may be prepared by mixing or stirring the materials in the following sequence.
(1) Tetraethyl orthosilicate, (3-glycidyloxypropyl)trimethoxysilane, methyl acetoacetate, and aluminum triisopropylate
(2) Acetic acid
(3) Silicon oxide (SiO₂)
(4) Epoxy resin and acetylacetone
(5) Surfactant
(6) Itaconic acid and dicyandiamide

A third aspect of the present disclosure provides a coating method using an anti-fog functional coating composition, the method including: forming a coating layer on a substrate using the composition according to the present disclosure.

Substrates to which the composition of the present disclosure may be applied include, for example, metal substrates, glass substrates, and polymer substrates, but are not limited thereto.

A fourth aspect of the present disclosure provides a coating object coated with the composition according to the present disclosure. Herein, the term “coated object” should be interpreted as including both a coating layer and the entire substrate on which the coating layer is formed. For example, the coated object may be a coated metal substrate, a coated glass substrate, or a coated polymer substrate, but is not limited thereto.

### MODE FOR CARRYING OUT THE INVENTION

### Example 1. Preparation of Anti-Fog Functional Coating Composition

A composition was prepared through the following processes.

1) 79 g of tetraethyl orthosilicate, 305 g of (3-glycidyloxypropyl)trimethoxysilane, 78 g of methyl acetoacetate, and 20 g of aluminum triisopropylate were simultaneously stirred for about 30 minutes.

2) 165 g of acetic acid was added to the above four materials, and the mixture was stirred for about 2 hours until it was well dissolved and became transparent.

3) 232 g of silicon oxide in the form of Optisol was added, and the mixture was stirred at 45° C. for 1 hour.

4) 39 g of epoxy resin and 50 g of acetylacetone were added, and the mixture was stirred at 35° C. for about 1 hour.

5) 12 g of a surfactant was added and stirred.

6) 7 g of itaconic acid and 13 g of dicyandiamide were added, followed by stirring for about 2 hours to complete the preparation of the composition.

In order to evaluate the effects of the present disclosure, the prepared composition was applied to a lens to form a coating (RayMaterials anti-fog coated lens), and comparative tests were conducted with commercially available anti-fog coated lens products from other companies (Examples 2, 3, and 4).

Information on competitor products A, B, and C is shown in the table below.

TABLE 2

| | Company A | Company B | Company C |
|---|---|---|---|
| Company Name | SHAMIR | Essilor Int. | TOKAI OPTICAL |
| | | | CO., LTD |
| Product Name | SV ALTIE, | Optifog UV | HX-AS UV MFC |
| | 1.6GlacierPlus | Einstrken | |
| | Anti-fog lens | Ormix | |

### Example 2. Accelerated Aging Test

An accelerated aging test was conducted in accordance with the test specifications based on the “Class 1 Medical Device Standards” for “Spectacle Lenses,” as stipulated in the “Regulations on Medical Device Categories and Classification by Category” notified by the Ministry of Food and Drug Safety (MFDS) of the Republic of Korea (ISO 8980-4:2006 Ophthalmic optics—Uncut finished spectacle lenses—Part 4: Specifications and test methods for anti-reflective coatings (clause 5.6 Determination of durability)).

The general test setup is as follows.

a) Evaluations were performed before and after a weathering test using a Weather-Ometer.

b) A xenon lamp was set to provide an irradiance of 0.85 W/m²·nm at 340 nm.

c) 30 min light @(63±3)° C. BPT/5 min light & Water spray

d) Total test duration: 16 h

e) Based on the central part of the sample

f) A cloth sufficiently soaked in distilled water at (23±5)° C. was folded into three layers and fixed to an eraser abrasion tester. Then, the lens surface was rubbed under a vertical force of 5 N for 25 reciprocating cycles at 60 rpm.

g) Surface changes were visually observed, and an anti-fog test was conducted.

The test results are shown in the table below.

TABLE 3

| | | RayMaterials | Company A | Company B | Company C |
|---|---|---|---|---|---|
| Transmittance | | Anti-fog coated | Anti-fog coated | Anti-fog coated | Anti-fog coated |
| Test | | lens | lens | lens | lens |
| Test 1 | Visual | PASS | FAIL - Surface | FAIL - Surface | FAIL - Surface |
| | observation | | scratching | scratching | scratching |
| | Anti-fog | PASS - Fogging | FAIL - Fogging | FAIL - Fogging | FAIL - Fogging |
| | test | duration of 8 | duration of 1 | duration of 1 | duration of 1 |
| | | seconds or longer | second | second | second |
| Test 2 | Visual | PASS | FAIL - Surface | FAIL - Surface | FAIL - Surface |
| | observation | | scratching | scratching | scratching |
| | Anti-fog | PASS - Fogging | FAIL - Fogging | FAIL - Fogging | FAIL - Fogging |
| | test | duration of 8 | duration of 2 | duration of 1 | duration of 2 |
| | | seconds or longer | seconds | second | seconds |
| Test 3 | Visual | PASS | FAIL - Surface | FAIL - Surface | FAIL - Surface |
| | observation | | scratching | scratching | scratching |
| | Anti-fog | PASS - Fogging | FAIL - Fogging | FAIL - Fogging | FAIL - Fogging |
| | test | duration of 8 | duration of 1 | duration of 1 | duration of 1 |
| | | seconds or longer | second | second | second |
| Test 4 | Visual | PASS | FAIL - Surface | FAIL - Surface | FAIL - Surface |
| | observation | | scratching | scratching | scratching |
| | Anti-fog | PASS - Fogging | FAIL - Fogging | FAIL - Fogging | FAIL - Fogging |
| | test | duration of 8 | duration of 1 | duration of 1 | duration of 1 |
| | | seconds or longer | second | second | second |
| Test 5 | Visual | PASS | FAIL - Surface | FAIL - Surface | FAIL - Surface |
| | observation | | scratching | scratching | scratching |
| | Anti-fog | PASS - Fogging | FAIL - Fogging | FAIL - Fogging | FAIL - Fogging |
| | test | duration of 8 | duration of 2 | duration of 2 | duration of 2 |
| | | seconds or longer | seconds | seconds | seconds |
| Test 6 | Visual | PASS | FAIL - Surface | FAIL - Surface | FAIL - Surface |
| | observation | | scratching | scratching | scratching |
| | Anti-fog | PASS - Fogging | FAIL - Fogging | FAIL - Fogging | FAIL - Fogging |
| | test | duration of 8 | duration of 1 | duration of 1 | duration of 1 |
| | | seconds or longer | second | second | second |
| Test 7 | Visual | PASS | FAIL - Surface | FAIL - Surface | FAIL - Surface |
| | observation | | scratching | scratching | scratching |
| | Anti-fog | PASS - Fogging | FAIL - Fogging | FAIL - Fogging | FAIL - Fogging |
| | test | duration of 8 | duration of 2 | duration of 1 | duration of 1 |
| | | seconds or longer | seconds | second | second |
| Test 8 | Visual | PASS | FAIL - Surface | FAIL - Surface | FAIL - Surface |
| | observation | | scratching | scratching | scratching |
| | Anti-fog | PASS - Fogging | FAIL - Fogging | FAIL - Fogging | FAIL - Fogging |
| | test | duration of 8 | duration of 1 | duration of 2 | duration of 1 |
| | | seconds or longer | second | seconds | second |
| Test 9 | Visual | PASS | FAIL - Surface | FAIL - Surface | FAIL - Surface |
| | observation | | scratching | scratching | scratching |
| | Anti-fog | PASS - Fogging | FAIL - Fogging | FAIL - Fogging | FAIL - Fogging |
| | test | duration of 8 | duration of 1 | duration of 1 | duration of 2 |
| | | seconds or longer | second | second | seconds |
| Test 10 | Visual | PASS | FAIL - Surface | FAIL - Surface | FAIL - Surface |
| | observation | | scratching | scratching | scratching |
| | Anti-fog | PASS - Fogging | FAIL - Fogging | FAIL - Fogging | FAIL - Fogging |
| | test | duration of 8 | duration of 1 | duration of 1 | duration of 1 |
| | | seconds or longer | second | second | second |

In the table above, the criterion for PASS was defined as a duration of 8 seconds or longer for the light transmittance to decrease to 80% or less of the initial light transmittance due to fogging (EN 166:2002 (Personal eye-protection Specifications) (clause 7.3.2) and ANSI Z87.1:2020 (American National Standard for Occupational and Educational Personal Eye and Face Protection Devices) (clause 6.2)). As a result of the tests, the lens coated with the coating composition according to the present disclosure exhibited superior transmittance compared to the other lenses.

### Example 3. Pencil Hardness Test

The hardness of the coating surface was evaluated by recording the hardness of the hardest pencil that failed to damage the surface when the pencil was scratched at an angle of 45° while applying a force of (7.5±0.1) N. The hardness was determined according to the following sequence, ranging from softest to hardest: 9B-8B-7B-6B-5B-4B-3B-2B-B-HB-F-H-2H-3H-4H-5H-6H-7H-8H-9H.

The test results are shown in the table below.

TABLE 4

| | RayMaterials | Company A | Company B | Company C |
|---|---|---|---|---|
| | Anti-fog | Anti-fog | Anti-fog | Anti-fog |
| | coated | coated | coated | coated |
| Test No. | lens | lens | lens | lens |
| Test 1 | 2H | 3B | 2B | B |
| Test 2 | H | 2B | 3B | 2B |
| Test 3 | H | 3B | 3B | 2B |
| Test 4 | 2H | 3B | 2B | 2B |
| Test 5 | 2H | 3B | 2B | B |
| Test 6 | 2H | 2B | 3B | B |
| Test 7 | 2H | 2B | 3B | B |
| Test 8 | H | 3B | 3B | 2B |
| Test 9 | 2H | 3B | 2B | B |
| Test 10 | 2H | 3B | 2B | B |

As a result of the tests, it was confirmed that the lens coated with the coating composition according to the present disclosure exhibited the highest hardness in all cases. That is, it was confirmed that the present disclosure provides superior durability compared to conventional coating technologies, and thus a product coated with the composition of the present disclosure can maintain a semi-permanent anti-fog effect.

### Example 4. Scratch Resistance and Transmittance Change Test

A test was conducted to compare scratch resistance and changes in transmittance between the present disclosure and the competitive products according to the following processes:

a) 3 kg of fine natural quartz sand with a grain size of 0.5 mm to 0.7 mm was dropped onto a rotating sample (lens) using a specialized apparatus.

b) The lens surface was washed with running distilled water or deionized water, and then carefully dried with a lint-free and grease-free cloth.

c) The change in transmittance was measured.

The test results are shown in the table below.

TABLE 5

| | | RayMaterials | Company A | Company B | Company C |
|---|---|---|---|---|---|
| | | Anti-fog | Anti-fog | Anti-fog | Anti-fog |
| Transmittance | | coated | coated | coated | coated |
| Test | | lens | lens | lens | lens |
| Test 1 | Before | 93.59% | 94.32% | 92.21% | 93.33% |
| | After | 91.32% | 89.25% | 87.55% | 87.37% |
| Test 2 | Before | 93.43% | 94.27% | 91.97% | 93.27% |
| | After | 91.24% | 88.87% | 87.31% | 86.87% |
| Test 3 | Before | 93.56% | 94.56% | 92.36% | 92.78% |
| | After | 91.33% | 88.61% | 88.19% | 87.59% |
| Test 4 | Before | 93.47% | 94.33% | 92.52% | 93.15% |
| | After | 91.21% | 89.11% | 87.29% | 86.92% |
| Test 5 | Before | 93.59% | 94.32% | 92.31% | 93.33% |
| | After | 91.32% | 89.25% | 87.56% | 87.37% |
| Test 6 | Before | 93.45% | 94.28% | 91.93% | 93.26% |
| | After | 91.11% | 88.88% | 87.28% | 86.78% |
| Test 7 | Before | 93.76% | 94.58% | 92.33% | 92.77% |
| | After | 91.39% | 88.63% | 87.27% | 87.53% |
| Test 8 | Before | 93.37% | 94.39% | 92.56% | 93.20% |
| | After | 91.22% | 89.17% | 88.19% | 86.85% |
| Test 9 | Before | 93.51% | 94.43% | 91.87% | 93.30% |
| | After | 91.28% | 89.09% | 88.14% | 87.18% |
| Test 10 | Before | 93.44% | 94.52% | 91.80% | 93.25% |
| | After | 91.25% | 89.11% | 88.09% | 87.10% |

As a result of the tests, it was found that in all cases, the change in transmittance was the smallest for the lens coated with the coating composition according to the present disclosure. The average change in transmittance of the lens according to the present disclosure was −2.25 percentage points (% P), whereas the average changes in transmittance of the competitive products were −5.40% P, −4.50% P, and −6.01% P, respectively, in order from left to right as shown in the table. That is, it was confirmed that the present disclosure provides superior durability compared to conventional coating technologies, and thus a product coated with the composition of the present disclosure can maintain a semi-permanent anti-fog effect.

The above description of the present disclosure is provided for the purpose of illustration, and it would be understood by a person with ordinary skill in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

### EXPLANATION OF CODES

100: Coating layer
110: Hydrophilic material
120: Hydrophobic material
130: Trench-structure or groove-structure
190: Substrate

We claim:

1. An anti-fog functional coating composition, comprising:
a hydrophilic material and a hydrophobic material,
wherein a trench-structure or groove-structure is formed in a coating layer after coating.

2. The anti-fog coating composition of claim 1,
wherein a degree of anti-fog functionality of the composition is controlled by adjusting a mixing ratio of the hydrophilic material and the hydrophobic material.

3. The anti-fog coating composition of claim 1,
wherein a surface area of the coating layer is increased by the trench-structure or groove-structure.

4. The anti-fog coating composition of claim 1,
wherein the hydrophilic material includes at least one selected from the group consisting of (3-glycidyloxypropyl)trimethoxysilane, silicon oxide (SiO₂), epoxy resin, polyethylene glycol (PEG), polyvinyl alcohol, polyvinyl acetate, polyvinyl pyrrolidone, and polyoxazoline, and
the hydrophobic material includes at least one selected from the group consisting of chromium oxide, aluminum triisopropylate, polycarbonate, polyethylene terephthalate glycol, and polypropylene.

5. The anti-fog coating composition of claim 1,
wherein the trench-structure or groove-structure is formed using a trench-structure or groove-structure forming agent.

6. The anti-fog coating composition of claim 5,
wherein the trench-structure or groove-structure forming agent includes at least one of itaconic acid and dicyandiamide.

7. A method of preparing an anti-fog functional coating composition, the method comprising:
stirring a hydrophilic material, a hydrophobic material, and a trench-structure or groove-structure forming agent.

8. The method of claim 7,
wherein a degree of anti-fog functionality is controlled by adjusting a mixing ratio of the hydrophilic material and the hydrophobic material.

9. The method of claim 7,
wherein the hydrophilic material includes at least one selected from the group consisting of (3-glycidyloxypropyl)trimethoxysilane, silicon oxide (SiO₂), epoxy resin, polyethylene glycol (PEG), polyvinyl alcohol, polyvinyl acetate, polyvinyl pyrrolidone, and polyoxazoline, and
the hydrophobic material includes at least one selected from the group consisting of chromium oxide, aluminum triisopropylate, polycarbonate, polyethylene terephthalate glycol, and polypropylene.

10. The method of claim 7,
wherein the trench-structure or groove-structure forming agent includes at least one of itaconic acid and dicyandiamide.

11. A coating method using an anti-fog functional coating composition, the method comprising:
forming a coating layer on a substrate using a composition of any one of claim 1.

12. The coating method of claim 11,
wherein the substrate is any one selected from the group consisting of a metal substrate, a glass substrate, and a polymer substrate.

13. A coating object coated with a composition of any one of claim 1.
